(19) United States
(12) Patent Application Publication
(10) Pub. No.: US 2024/0232586 A9
(43) Pub. Date: Jul. 11, 2024

(54) TOPOLOGY-AUGMENTED SYSTEM FOR AI-MODEL MISMATCH

(71) Applicant: Raytheon Company, Waltham, MA (US)

(72) Inventors: Ganesh Sundaramoorthi, Duluth, GA (US); Michael R. Salpukas, Lexington, MA (US)

(21) Appl. No.: 17/972,135

(22) Filed: Oct. 24, 2022

(51) Int. Cl. G06N 3/04

(52) U.S. Cl. CPC G06N 3/0472

(57) ABSTRACT

A system and method estimate an uncertainty of an artificial neural network. A topological uncertainty of the artificial neural network is determined by forming a bipartite graph between input and output nodes in a layer of the artificial neural network, and generating a persistence diagram as a function of the bipartite graph. A latent uncertainty of the artificial neural network is then determined, and the uncertainty of the artificial neural network is estimated as a function of the topological uncertainty and the latent uncertainty.

### TECHNICAL FIELD

Embodiments described herein generally relate to a topology-augmented system for AI-model mismatch, and in an embodiment, but not by way of limitation, a system and method for estimating uncertainty in an artificial neural network.

### BACKGROUND

Many users of artificial neural networks require an accurate neural network uncertainty estimation prior to integration of the artificial neural network into field or production systems. It is particularly important to have an accurate uncertainty when utilizing artificial neural networks and artificial intelligence in military defense systems. That is, determining whether the prediction of the artificial neural network can be trusted.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a block diagram illustrating an embodiment of a topology-augmented system for AI-model mismatch.

FIGS. 2A and 2B are a block diagram illustrating operations and features of an embodiment of a topology-augmented system for AI-model mismatch.

FIG. 3 illustrates an example of a graph indicating an advantage of an embodiment of a topology-augmented system for AI-model mismatch.

FIG. 4 illustrates an embodiment of a computer architecture upon which one or more embodiments of the present disclosure can execute.

### DETAILED DESCRIPTION

A new method of determining the uncertainty of an artificial neural network (ANN) is disclosed, and it can be referred to as topology-augmented uncertainty. The new method for classification integrates ANN classification with out-of-distribution detection. In short, an out of distribution detection module is integrated with a deep learning ANN. It is edge-deployable, that is, an embodiment can be installed at locations wherein the real data are collected, such as in a military environment.

Specifically, in embodiment, given input data and a trained ANN, the system determines whether the data are out-of-distribution relative to the training data set and then determines if the ANN can reliably make a prediction. One application area is in a Synthetic Aperture Rader (SAR) based Automatic Target Recognition (ATR) of military vehicles with deep networks. The deployment of such a system in practice requires out-of-distribution detection capabilities to determine when the ATR cannot be trusted. There are also many other applications for this and other embodiments of this disclosure.

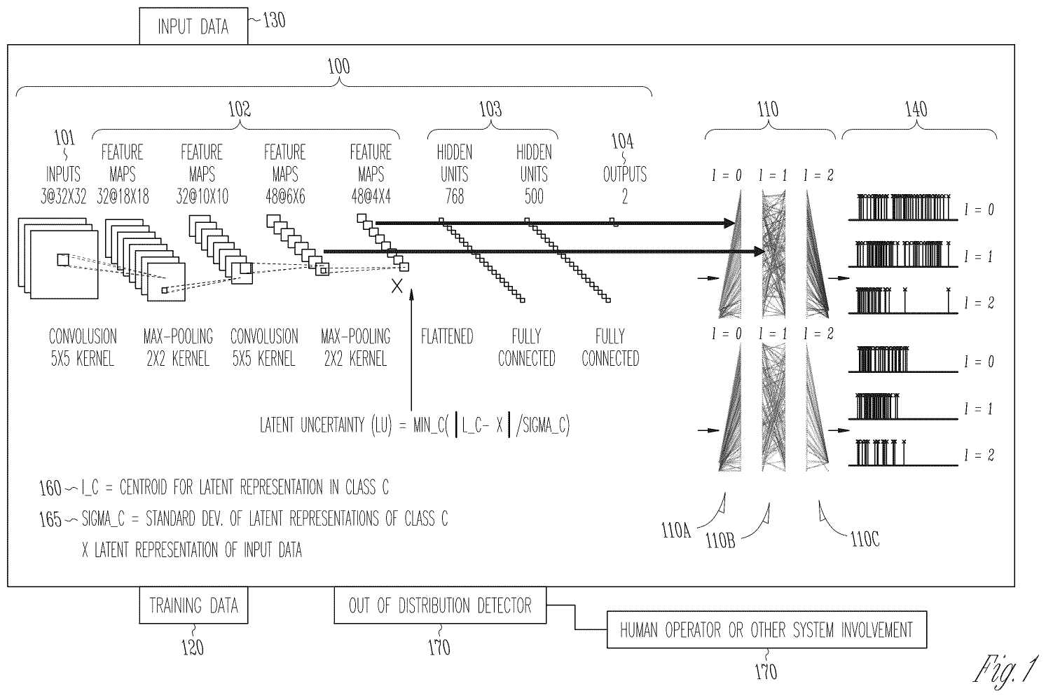

FIG. 1 illustrates a system for determining an uncertainty of an ANN 100. The ANN 100 includes several layers—an input layer 101, feature maps 102, hidden units or layers 103, and an output layer 104. As further illustrated in FIG. 1, the ANN 100 can be a convolution ANN and fully connected, that it, each input node in a layer is connected to each output node in that layer. This is further illustrated at 110, wherein input data at 110A are input into the ANN 100, are connected to many nodes in the network at 110B, and after processing in the fully connected layers of the network, the data are output at 110C.

The ANN 100 is first trained with training data 120. After training, input data 130 for which a prediction is desired are input in the ANN 100. As indicated in FIG. 1, the input data can be image data from a radar system, and as noted above, this radar system can be a SAR-based system in an ATR military system. Using the input data 130, the ANN 100 generates bipartite graphs 140. These bipartite graphs are used to calculate a first uncertainty of the ANN 100 that can be referred to as a topological uncertainty. Specifically, for each layer in the ANN 100, bipartite graphs are formed between each of the input and output nodes in the layer. The edge weights of the bipartite graph are a function of the weight matrix for the particular layer, and the data that are input into that particular layer. Using the bipartite graphs, a persistence diagram is computed as follows.

$$\\ TU ( x , F ) := \frac{1}{L} {\sum }_{ℓ = 1}^{L} Dist ( {D}_{ℓ} ( x , F ) , \overline{{D}_{ℓ , k ( x )}^{{}^{} train}} {}^{} {}^{} ) ,$$

wherein L comprises a number of layers in the artificial neural network;
wherein l comprises a particular layer in the artificial neural network;
wherein x comprises an input data value;
wherein F comprises a description of the artificial neural network;
wherein k(x) comprises a class of x derived from processing by the artificial neural network; and
wherein D^{train} comprises an average of data used to train the artificial neural network.
The description F of the ANN represents the activation maps of the neural network relative to specific input data, characterizing the response of the neural network to that particular data example.

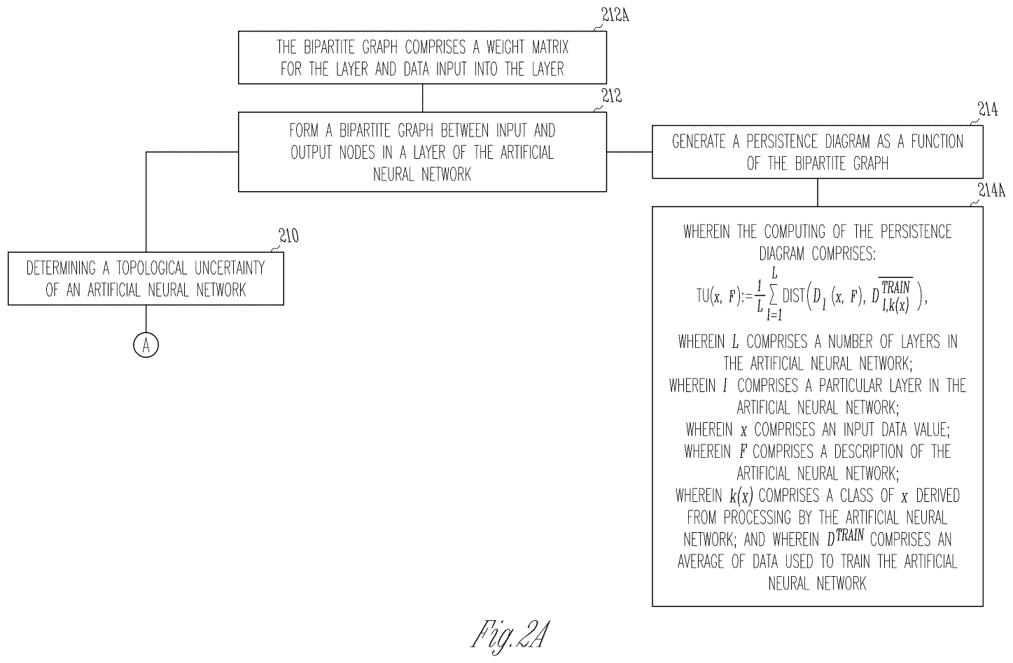

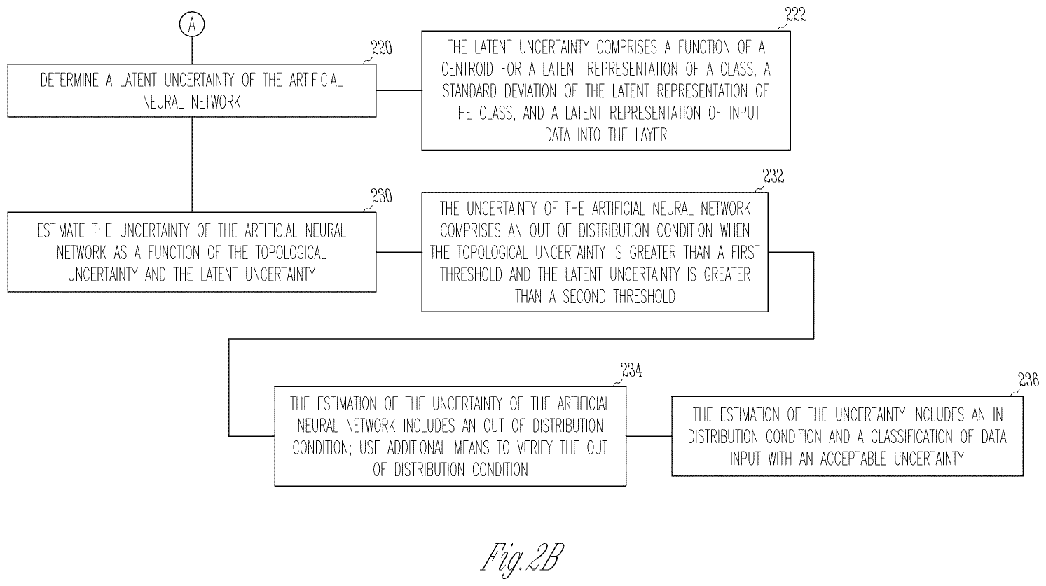

From the persistence diagram, the topological uncertainty of the layer can be calculated as defined in FIG. 2A. After the computation of the topological uncertainty, the latent uncertainty is calculated. As indicated at 160 in FIG. 1, the latent uncertainty of the ANN 100 is a function of the centroid of the data of a particular class of an object (such as a tank) under consideration. A standard deviation 165 of that class data is then determined. After the determination of the latent uncertainty, an uncertainty of the ANN 100, which can be referred to as an out of distribution condition (OOD), is determined at 170. Specifically, if both the topological uncertainty is greater than a topological threshold, and the latent uncertainty is greater than a latent threshold, then a determination is made that the results of the ANN 100 are uncertain. The thresholds are chosen through analysis of Receiver Operator Characteristics (ROC Curves) to balance probability of detection vs. probability of false alarm. If the result is judged uncertain, then a human analysis or other system analysis must be employed at 172. If that is not the condition, that is, both the topological uncertainty and the latent uncertainty are not greater than their respective thresholds, then it can be concluded that the results of the ANN 100 are in distribution, and the data that were input into the ANN 100 are properly classified.

FIGS. 2A and 2B are a block diagram illustrating operations and features of a system for determining the uncertainty of an ANN. FIGS. 2A and 2B include a number of feature and process blocks 210-236. Though arranged substantially serially in the example of FIGS. 2A and 2B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now specifically to FIGS. 2A and 2B, a topological uncertainty of the ANN is determined. This topological uncertainty is determined by first forming a bipartite graph between input and output nodes in a layer of the ANN (212), and then generating a persistence diagram as a function of the bipartite graph (214). As noted at 212A, the bipartite graph includes a weight matrix for the layer and data input into the layer. Further, as noted at 214A, the computing of the persistence diagram comprises:

$$\\ TU ( x , F ) := \frac{1}{L} {\sum }_{ℓ = 1}^{L} Dist ( {D}_{ℓ} ( x , F ) , \overline{{D}_{ℓ , k ( x )}^{{}^{} train}} {}^{} {}^{} ) ,$$

wherein L comprises a number of layers in the artificial neural network;
wherein l comprises a particular layer in the artificial neural network;
wherein x comprises an input data value;
wherein F comprises a description of the artificial neural network;
wherein k(x) comprises a class of x derived from processing by the artificial neural network; and
wherein D^{train} comprises an average of data used to train the artificial neural network.

Then, at 220, a latent uncertainty of the ANN is determined. The latent uncertainty includes a function of a centroid for a latent representation of a class, a standard deviation of the latent representation of the class, and a latent representation of input data into the layer (222).

At 230, the uncertainty of the ANN is estimated as a function of the topological uncertainty and the latent uncertainty. More specifically, as indicated at 232, the uncertainty of the ANN is in an out of distribution condition when the topological uncertainty is greater than a first threshold and the latent uncertainty is greater than a second threshold. If the uncertainty is in an out of distribution condition, additional means are used to obtain the output classification (234). If the uncertainty is in an in distribution condition, then it can be concluded that the input data has been classified with an acceptable uncertainty (236).

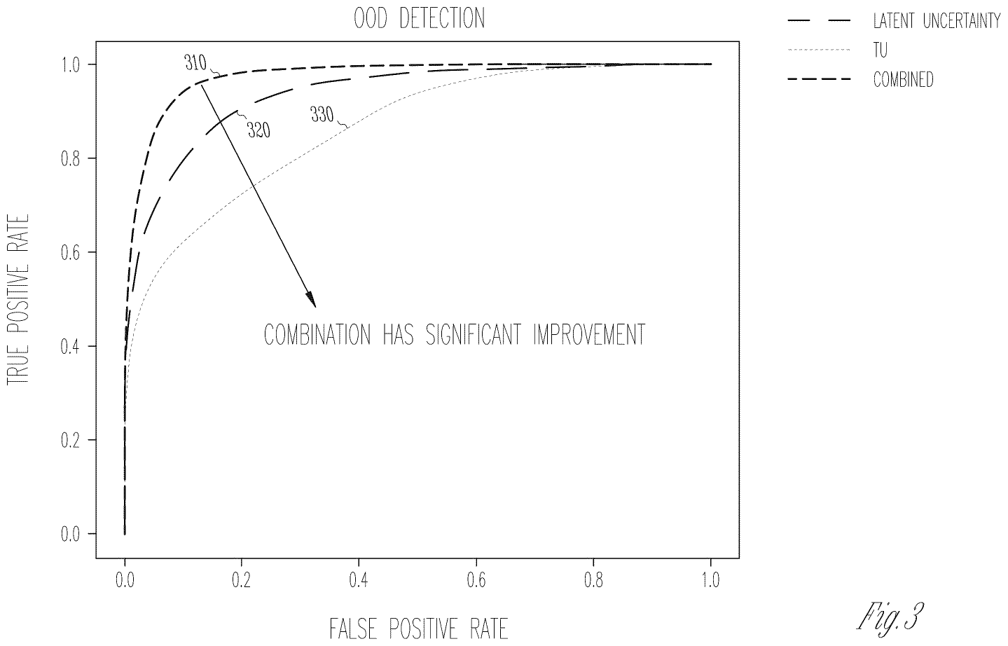

The benefit of a combination of the topological uncertainty and the latent uncertainty of an ANN is illustrated in FIG. 3. FIG. 3 illustrates the results of a simple three-layer network that was trained with the adaptive moment estimation (Adam) optimizer and modified National Institute of Standards and Technology (MNIST) datasets. In this example, the topological uncertainty was measured on all layers but the first layer, and the latent uncertainty was based on clusters of the MNIST datasets in the latent space. FIG. 3 plots the false positive rate versus the true positive rate of this test. As can be seen from FIG. 3, the combination of the topological uncertainty and the latent uncertainty at 310 produces a higher true positive rate that either of the topological uncertainty 320 and the latent uncertainty 330. FIG. 3 illustrates that the topological uncertainty and the latent uncertainty have complementary information about an out of distribution condition of the artificial neural network, thereby validating the practicality of ensemble against separate measures.

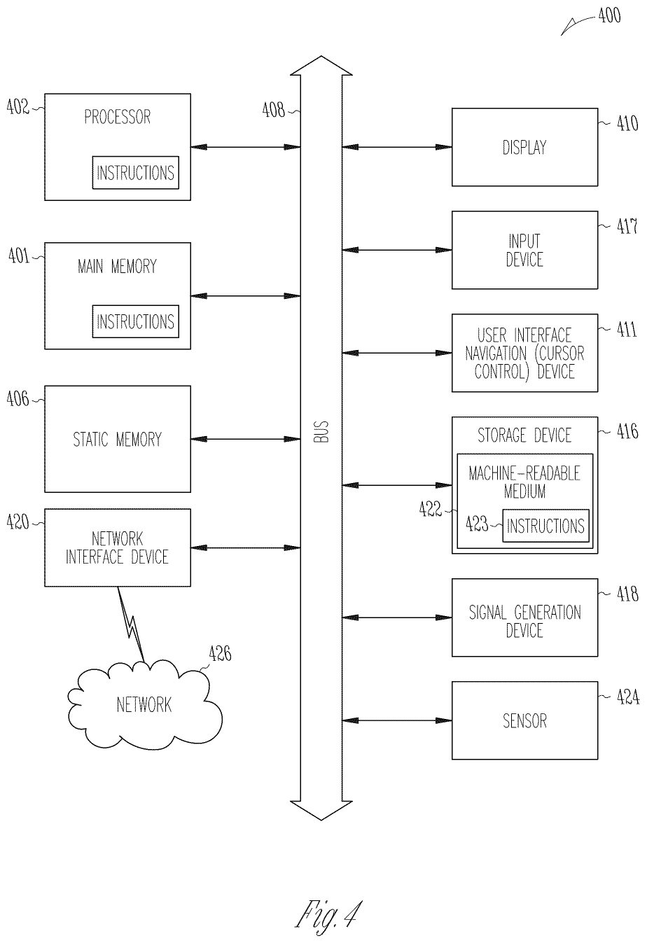

FIG. 4 is a block diagram illustrating a computing and communications platform 400 in the example form of a general-purpose machine on which some or all the operations of FIGS. 1 and 2 may be carried out according to various embodiments. In certain embodiments, programming of the computing platform 400 according to one or more particular algorithms produces a special-purpose machine upon execution of that programming. In a networked deployment, the computing platform 400 may operate in the capacity of either a server or a client machine in server-client network environments, or it may act as a peer machine in peer-to-peer (or distributed) network environments.

Example computing platform 400 includes at least one processor 402 (e.g., a central processing unit (CPU), a graphics processing unit (GPU) or both, processor cores, compute nodes, etc.), a main memory 401 and a static memory 406, which communicate with each other via a link 408 (e.g., bus). The computing platform 400 may further include a video display unit 410, input devices 417 (e.g., a keyboard, camera, microphone), and a user interface (UI) navigation device 411 (e.g., mouse, touchscreen). The computing platform 400 may additionally include a storage device 416 (e.g., a drive unit), a signal generation device 418 (e.g., a speaker), a sensor 424, and a network interface device 420 coupled to a network 426.

The storage device 416 includes a non-transitory machine-readable medium 422 on which is stored one or more sets of data structures and instructions 423 (e.g., software) embodying or utilized by any one or more of the methodologies or functions described herein. The instructions 423 may also reside, completely or at least partially, within the main memory 401, static memory 406, and/or within the processor 402 during execution thereof by the computing platform 400, with the main memory 401, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 423. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### EXAMPLES

Example No. 1 is a process for estimating an uncertainty of an artificial neural network comprising determining a topological uncertainty of the artificial neural network by forming a bipartite graph between input and output nodes in a layer of the artificial neural network and generating a persistence diagram as a function of the bipartite graph; determining a latent uncertainty of the artificial neural network; and estimating the uncertainty of the artificial neural network as a function of the topological uncertainty and the latent uncertainty.

Example No. 2 includes all the features of Example No. 1, and optionally includes a process wherein the bipartite graph comprises a weight matrix for the layer and data input into the layer.

Example No. 3 includes all the features of Example Nos. 1-2, and optionally includes a process wherein the latent uncertainty comprises a function of a centroid for a latent representation of a class, a standard deviation of the latent representation of the class, and a latent representation of input data into the layer.

Example No. 4 includes all the features of Example Nos. 1-3, and optionally includes a process wherein the uncertainty of the artificial neural network comprises an out of distribution condition when the topological uncertainty is greater than a first threshold and the latent uncertainty is greater than a second threshold.

Example No. 5 includes all the features of Example Nos. 1-4, and optionally includes a process wherein the computing of the persistence diagram comprises:

$$\\ TU ( x , F ) := \frac{1}{L} {\sum }_{ℓ = 1}^{L} Dist ( {D}_{ℓ} ( x , F ) , \overline{{D}_{ℓ , k ( x )}^{{}^{} train}} {}^{} {}^{} ) ,$$

wherein L comprises a number of layers in the artificial neural network;
wherein l comprises a particular layer in the artificial neural network;
wherein x comprises an input data value;
wherein F comprises a description of the artificial neural network;
wherein k(x) comprises a class of x derived from processing by the artificial neural network; and
wherein D^{train} comprises an average of data used to train the artificial neural network.

Example No. 6 includes all the features of Example Nos. 1-5, and optionally includes a process wherein the estimating the uncertainty of the artificial neural network comprises an out of distribution condition, and comprising using additional means to verify the out of distribution condition.

Example No. 7 includes all the features of Example Nos. 1-6, and optionally includes a process wherein the estimating the uncertainty comprises an in distribution condition and a classification of data input with an acceptable uncertainty.

Example No. 8 is a machine-readable medium comprising instructions that when executed by a processor executes a process comprising determining a topological uncertainty of the artificial neural network by forming a bipartite graph between input and output nodes in a layer of the artificial neural network and generating a persistence diagram as a function of the bipartite graph; determining a latent uncertainty of the artificial neural network; and estimating the uncertainty of the artificial neural network as a function of the topological uncertainty and the latent uncertainty.

Example No. 9 includes all the features of Example No. 8, and optionally includes a machine-readable medium wherein the bipartite graph comprises a weight matrix for the layer and data input into the layer.

Example No. 10 includes all the features of Example Nos. 8-9, and optionally includes a machine-readable medium wherein the latent uncertainty comprises a function of a centroid for a latent representation of a class, a standard deviation of the latent representation of the class, and a latent representation of input data into the layer.

Example No. 11 includes all the features of Example Nos. 8-10, and optionally includes a machine-readable medium wherein the uncertainty of the artificial neural network comprises an out of distribution condition when the topological uncertainty is greater than a first threshold and the latent uncertainty is greater than a second threshold.

Example No. 12 includes all the features of Example Nos. 8-11, and optionally includes a machine-readable medium wherein the computing of the persistence diagram comprises:

$$\\ TU ( x , F ) := \frac{1}{L} {\sum }_{ℓ = 1}^{L} Dist ( {D}_{ℓ} ( x , F ) , \overline{{D}_{ℓ , k ( x )}^{{}^{} train}} {}^{} {}^{} ) ,$$

wherein L comprises a number of layers in the artificial neural network;
wherein l comprises a particular layer in the artificial neural network;
wherein x comprises an input data value;
wherein F comprises a description of the artificial neural network;
wherein k(x) comprises a class of r derived from processing by the artificial neural network; and
wherein D^{train} comprises an average of data used to train the artificial neural network.

Example No. 13 includes all the features of Example Nos. 8-12, and optionally includes a machine-readable medium wherein the estimating the uncertainty of the artificial neural network comprises an out of distribution condition, and comprising using additional means to verify the out of distribution condition.

Example No. 14 includes all the features of Example Nos. 8-13, and optionally includes a machine-readable medium wherein the estimating the uncertainty comprises an in distribution condition and a classification of data input with an acceptable uncertainty.

Example No. 15 is a system including a computer processor and a memory coupled to the computer processor; wherein the computer processor and the memory are operable for determining a topological uncertainty of an artificial neural network by forming a bipartite graph between input and output nodes in a layer of the artificial neural network and generating a persistence diagram as a function of the bipartite graph; determining a latent uncertainty of the artificial neural network; and estimating the uncertainty of the artificial neural network as a function of the topological uncertainty and the latent uncertainty.

Example No. 16 includes all the features of Example No. 15, and optionally includes a system wherein the latent uncertainty comprises a function of a centroid for a latent representation of a class, a standard deviation of the latent representation of the class, and a latent representation of input data into the layer.

Example No. 17 includes all the features of Example Nos. 15-16, and optionally includes a system wherein the uncertainty of the artificial neural network comprises an out of distribution condition when the topological uncertainty is greater than a first threshold and the latent uncertainty is greater than a second threshold.

Example No. 18 includes all the features of Example Nos. 15-17, and optionally includes a system wherein the computing of the persistence diagram comprises:

$$\\ TU ( x , F ) := \frac{1}{L} {\sum }_{ℓ = 1}^{L} Dist ( {D}_{ℓ} ( x , F ) , \overline{{D}_{ℓ , k ( x )}^{{}^{} train}} {}^{} {}^{} ) ,$$

wherein L comprises a number of layers in the artificial neural network;
wherein l comprises a particular layer in the artificial neural network;
wherein x comprises an input data value;
wherein F comprises a description of the artificial neural network;
wherein k(x) comprises a class of x derived from processing by the artificial neural network; and
wherein D^{train} comprises an average of data used to train the artificial neural network.

Example No. 19 includes all the features of Example Nos. 15-18, and optionally includes a system wherein the estimating the uncertainty of the artificial neural network comprises an out of distribution condition, and comprising using additional means to verify the out of distribution condition.

Example No. 20 includes all the features of Example Nos. 15-19, and optionally includes a system wherein the estimating the uncertainty comprises an in distribution condition and a classification of data input with an acceptable uncertainty.

1. A process for estimating an uncertainty of an artificial neural network comprising:
determining a topological uncertainty of the artificial neural network by:
forming a bipartite graph between input and output nodes in a layer of the artificial neural network; and
generating a persistence diagram as a function of the bipartite graph;
determining a latent uncertainty of the artificial neural network; and
estimating the uncertainty of the artificial neural network as a function of the topological uncertainty and the latent uncertainty.

2. The process of claim 1, wherein the bipartite graph comprises a weight matrix for the layer and data input into the layer.

3. The process of claim 1, wherein the latent uncertainty comprises a function of a centroid for a latent representation of a class, a standard deviation of the latent representation of the class, and a latent representation of input data into the layer.

4. The process of claim 1, wherein the uncertainty of the artificial neural network comprises an out of distribution condition when the topological uncertainty is greater than a first threshold and the latent uncertainty is greater than a second threshold.

5. The process of claim 1, wherein the computing of the persistence diagram comprises:
$$\\ TU ( x , F ) := \frac{1}{L} {\sum }_{ℓ = 1}^{L} Dist ( {D}_{ℓ} ( x , F ) , \overline{{D}_{ℓ , k ( x )}^{{}^{} train}} {}^{} {}^{} ) ,$$
wherein L comprises a number of layers in the artificial neural network;
wherein l comprises a particular layer in the artificial neural network;
wherein x comprises an input data value;
wherein F comprises a description of the artificial neural network;
wherein k(x) comprises a class of x derived from processing by the artificial neural network; and
wherein D^{train} comprises an average of data used to train the artificial neural network.

6. The process of claim 1, wherein the estimating the uncertainty of the artificial neural network comprises an out of distribution condition, and comprising using additional means to verify the out of distribution condition.

7. The process of claim 1, wherein the estimating the uncertainty comprises an in distribution condition and a classification of data input with an acceptable uncertainty.

8. A non-transitory machine-readable medium comprising instructions that when executed by a processor executes a process comprising:
determining a topological uncertainty of the artificial neural network by:
forming a bipartite graph between input and output nodes in a layer of the artificial neural network; and
generating a persistence diagram as a function of the bipartite graph;
determining a latent uncertainty of the artificial neural network; and
estimating the uncertainty of the artificial neural network as a function of the topological uncertainty and the latent uncertainty.

9. The non-transitory machine-readable medium of claim 8, wherein the bipartite graph comprises a weight matrix for the layer and data input into the layer.

10. The non-transitory machine-readable medium of claim 8, wherein the latent uncertainty comprises a function of a centroid for a latent representation of a class, a standard deviation of the latent representation of the class, and a latent representation of input data into the layer.

11. The non-transitory machine-readable medium of claim 8, wherein the uncertainty of the artificial neural network comprises an out of distribution condition when the topological uncertainty is greater than a first threshold and the latent uncertainty is greater than a second threshold.

12. The non-transitory machine-readable medium of claim 8, wherein the computing of the persistence diagram comprises:
$$\\ TU ( x , F ) := \frac{1}{L} {\sum }_{ℓ = 1}^{L} Dist ( {D}_{ℓ} ( x , F ) , \overline{{D}_{ℓ , k ( x )}^{{}^{} train}} {}^{} {}^{} ) ,$$
wherein L comprises a number of layers in the artificial neural network;
wherein l comprises a particular layer in the artificial neural network;
wherein x comprises an input data value;
wherein F comprises a description of the artificial neural network;
wherein k(x) comprises a class of x derived from processing by the artificial neural network; and
wherein D^{train} comprises an average of data used to train the artificial neural network.

13. The non-transitory machine-readable medium of claim 8, wherein the estimating the uncertainty of the artificial neural network comprises an out of distribution condition, and comprising using additional means to verify the out of distribution condition.

14. The non-transitory machine-readable medium of claim 8, wherein the estimating the uncertainty comprises an in distribution condition and a classification of data input with an acceptable uncertainty.

15. A system comprising:
a computer processor; and
a memory coupled to the computer processor;
wherein the computer processor and the memory are operable for determining a topological uncertainty of an artificial neural network by:
forming a bipartite graph between input and output nodes in a layer of the artificial neural network; and
generating a persistence diagram as a function of the bipartite graph;
determining a latent uncertainty of the artificial neural network; and
estimating the uncertainty of the artificial neural network as a function of the topological uncertainty and the latent uncertainty.

16. The system of claim 15, wherein the latent uncertainty comprises a function of a centroid for a latent representation of a class, a standard deviation of the latent representation of the class, and a latent representation of input data into the layer.

17. The system of claim 15, wherein the uncertainty of the artificial neural network comprises an out of distribution condition when the topological uncertainty is greater than a first threshold and the latent uncertainty is greater than a second threshold.

18. The system of claim 15, wherein the computing of the persistence diagram comprises:
$$\\ TU ( x , F ) := \frac{1}{L} {\sum }_{ℓ = 1}^{L} Dist ( {D}_{ℓ} ( x , F ) , \overline{{D}_{ℓ , k ( x )}^{{}^{} train}} {}^{} {}^{} ) ,$$
wherein L comprises a number of layers in the artificial neural network;
wherein l comprises a particular layer in the artificial neural network;
wherein x comprises an input data value;
wherein F comprises a description of the artificial neural network;
wherein k(x) comprises a class of x derived from processing by the artificial neural network; and
wherein D^{train} comprises an average of data used to train the artificial neural network.

19. The system of claim 15, wherein the estimating the uncertainty of the artificial neural network comprises an out of distribution condition, and comprising using additional means to verify the out of distribution condition.

20. The process of claim 1, wherein the estimating the uncertainty comprises an in distribution condition and a classification of data input with an acceptable uncertainty.
